(19) United States
(12) Patent Application Publication
(10) Pub. No.: US 2011/0169817 A1
(43) Pub. Date: Jul. 14, 2011

(54) APPARATUS FOR COMPENSATING FOR DETERIORATION IN AMOLED

(75) Inventors: Kyung Ho LEE, Gyunggi-do (KR); Youn Joong LEE, Seoul (KR); Byoung Won HWANG, Gyunggi-do (KR); Kyoung Soo KWON, Gyunggi-do (KR)

(73) Assignee: SAMSUNG ELECTRO-MECHANICS CO., LTD., Gyunggi-do (KR)

(21) Appl. No.: 12/873,369

(22) Filed: Sep. 1, 2010

(30) Foreign Application Priority Data
Jan. 12, 2010 (KR) 10-2010-0002878

(51) Int. Cl. G09G 5/00; G09G 3/30

(52) U.S. Cl. 345/213; 345/76

(57) ABSTRACT

There is provided an apparatus for compensating for deterioration in an active matrix organic light-emitting diode. An apparatus for compensating for deterioration in an active matrix organic light-emitting diode being operated by a pixel driving unit may include: a switching control unit being synchronized with an operation of the pixel driving unit to thereby generate a switching control signal in order to compensate for deterioration in a pixel; and a switch circuit unit connected between an anode of the active matrix organic light-emitting diode and a terminal of a deterioration compensation voltage, being turned on or off according to the switching control signal from the switching control unit, and supplying the deterioration compensation voltage to the anode of the active matrix organic light-emitting diode while being turned on.

### CROSS-REFERENCE TO RELATED APPLICATIONS

This application claims the priority of Korean Patent Application No. 10-2010-0002878 filed on Jan. 12, 2010, in the Korean Intellectual Property Office, the disclosure of which is incorporated herein by reference.

### BACKGROUND OF THE INVENTION

1. Field of the Invention

The present invention relates to an apparatus for compensating for deterioration in an AMOLED (active matrix organic light-emitting diode) applicable to an organic EL (electroluminescence) display, and more particularly, to an apparatus for compensating for deterioration in an AMOLED that can periodically compensate for deterioration in pixels.

2. Description of the Related Art

In the display field, research has been actively conducted so that various kinds of applications have appeared. Among those applications, pixels on a screen may deteriorate when a computer monitor or a TV display is turned on for long periods of time.

When deterioration has occurred in the pixels, parts of image data which are darker than other parts may be created, even though the same image data is output.

According to a conventional compensation method, in order to alleviate this problem, larger currents flow through the pixels being deteriorated. However, when larger currents flow through those pixels, the deterioration thereof may be accelerated.

### SUMMARY OF THE INVENTION

An aspect of the present invention provides an apparatus for compensating for deterioration in an active matrix organic light-emitting diode (AMOLED) that can reduce the occurrence of afterimages caused by screen deterioration and prevent image sticking by periodically compensating for deterioration in pixels.

According to an aspect of the present invention, there is provided an apparatus for compensating for deterioration in an active matrix organic light-emitting diode being operated by a pixel driving, the apparatus including: a switching control unit being synchronized with an operation of the pixel driving unit to thereby generate a switching control signal in order to compensate for deterioration in a pixel; and a switch circuit unit connected between an anode of the active matrix organic light-emitting diode and a terminal of a deterioration compensation voltage, being turned on or off according to the switching control signal from the switching control unit, and supplying the deterioration compensation voltage to the anode of the active matrix organic light-emitting diode while being turned on.

The switching circuit unit may be synchronized with a vertical synchronization signal of an image signal from the pixel driving unit to thereby generate the switching control signal in order to compensate for deterioration in a pixel.

The switching circuit unit may include a PMOS transistor having a source connected to the terminal of the deterioration compensation voltage, a gate connected to a terminal of the switching control signal of the switching control unit, and a drain connected to the anode of the active matrix organic light-emitting diode.

The deterioration compensation voltage may a voltage lower than an operating voltage being supplied to the cathode of the active matrix organic light-emitting diode.

The switching control unit may receive the vertical synchronization signal from an image processing unit supplying a switch signal to the pixel driving unit.

The vertical synchronization signal of the switching control unit may be synchronized with the switch signal from the image processing unit.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit block diagram illustrating an apparatus for compensating for deterioration in an active matrix organic light-emitting diode (AMOLED) according to an aspect of the present invention;

FIG. 2 is a timing chart illustrating the main signals according to an exemplary embodiment of the present invention; and

FIG. 3 is a view illustrating the concept of preventing deterioration in an active matrix organic light-emitting diode according to an exemplary embodiment of the present invention.

### DETAILED DESCRIPTION OF THE PREFERRED EMBODIMENT

Exemplary embodiments of the present invention will now be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

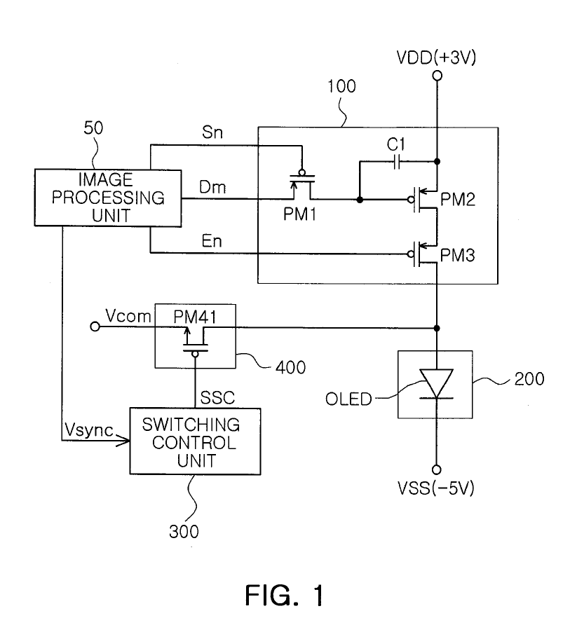

FIG. 1 is a circuit block diagram illustrating an apparatus for compensating for deterioration in an AMOLED (active matrix organic light-emitting diode) according to an exemplary embodiment of the invention.

Referring to FIG. 1, an apparatus for compensating for deterioration in an AMOLED (active matrix organic light-emitting diode) according to this embodiment compensates for deterioration in an active matrix organic light-emitting diode 200 being operated by a pixel driving unit 100. The apparatus for compensating for deterioration in an AMOLED may include a switching control unit 300 and a switch circuit unit 400. The switching control unit 300 is synchronized with the operation of the pixel driving unit 100 to thereby generate a switching control signal SSC in order to compensate for deterioration in pixels. The switch circuit unit 400 is connected between an anode of the active matrix organic light-emitting diode 200 and a terminal of a deterioration compensation voltage Vcom. The switch circuit unit 400 is turned on or off according to the switching control signal SSC generated from the switching control unit 300. When the switch circuit unit 400 is turned on, the switch circuit unit 400 supplies the deterioration compensation voltage Vcom to the anode of the active matrix organic light-emitting diode 200.

The active matrix organic light-emitting diode 200 may include at least one organic light emitting diode (OLED).

The switching control unit 300 may be synchronized with a vertical synchronization signal Vsync of an image signal from the pixel driving unit 100 to thereby generate the switching control signal SSC in order to compensate for deterioration in pixels.

The switch circuit unit 400 may include a PMOS transistor PM41 that has a source connected to the terminal of the deterioration compensation voltage Vcom, a gate connected to a terminal of the switching control signal SSC from the switching control unit 300, and a drain connected to the anode of the active matrix organic light-emitting diode 200.

Here, the deterioration compensation voltage Vcom may be set to a voltage lower than an operating voltage Vss being supplied to a cathode of the active matrix organic light-emitting diode 200.

Furthermore, the switching control unit 300 may receive the vertical synchronization signal Vsync from the image processing unit 50 that supplies a switch signal Sn to the pixel driving unit 100.

Here, the vertical synchronization signal Vsync from the switching control unit 300 may be synchronized with the switch signal Sn from the image processing unit 50.

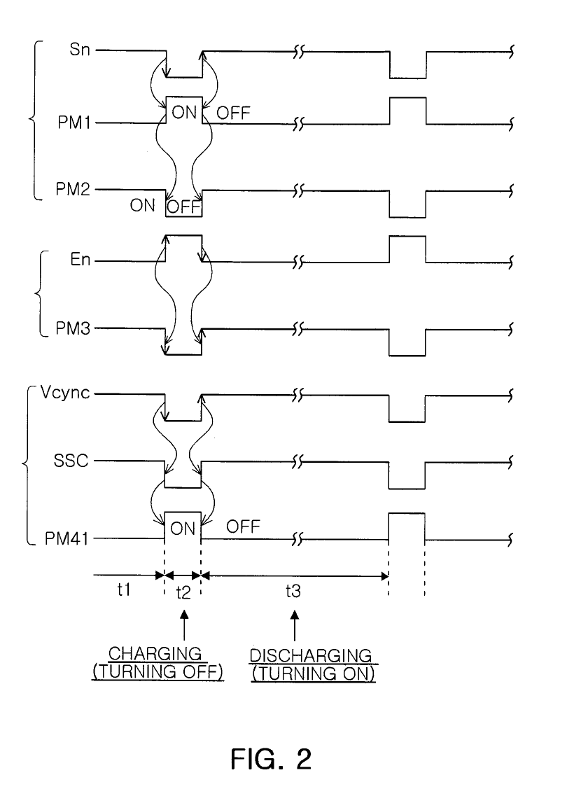

FIG. 2 is a timing chart illustrating the main signals according to an exemplary embodiment of the invention. In FIG. 2, a reference character Sn is a switch signal that is supplied to the pixel driving unit 100 from the image processing unit 50. Reference characters PM1, PM2, PM3 and PM4 refer to first, second, third and fourth PMOS transistors, respectively, a reference character En is an enable signal, a reference character Vsync refers to a vertical synchronization signal of an image signal, and a reference character SSC refers to a switching control signal.

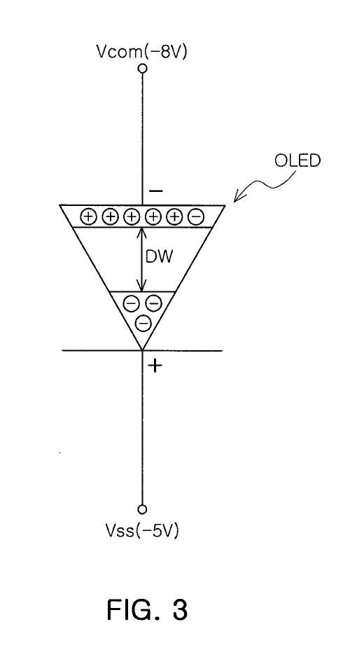

FIG. 3 is a view illustrating the concept of compensating for deterioration in an active matrix organic light-emitting diode (AMOLED) according to an exemplary embodiment of the invention. In FIG. 3, a reference character OLED refers to an organic light emitting diode, and a reference character DW refers to a width of a depletion layer.

Hereinafter, the operation and effects of the invention will now be described with reference to the accompanying drawings.

An apparatus for compensating for deterioration in an AMOLED (active matrix organic light-emitting diode) according to an exemplary embodiment of the invention will be described with reference to FIGS. 1 through 3. First, in FIG. 1, the apparatus for compensating for deterioration in an AMOLED (active matrix organic light-emitting diode) according to this embodiment compensates for deterioration in the active matrix organic light-emitting diode 200 being operated by the pixel driving unit 100.

The pixel driving unit 100 operates according to the switch signal Sn, the data memory signal Dm, and the enable signal En that are supplied from the image processing unit 50.

Here, as an operating example, in the pixel driving unit 100, the first PMOS transistor PM1 is switched on according to the switch signal Sn, and the second PMOS transistor PM2 is turned off according to the data memory signal Dm being supplied through the first PMOS transistor PM1 being switched on.

As such, when the first PMOS transistor PM1 is turned on, and the second PMOS transistor PM2 is turned off, the data memory signal Dm being supplied through the first PMOS transistor PM1 is charged in a first capacitor C1. Here, the, organic light emitting diode (OLED) is turned off.

As another operating example, in the pixel driving unit 100, when the first PMOS transistor PM1 is turned off according to the switch signal Sn, the first capacitor C1 is discharged, and the second PMOS transistor PM2 is turned on.

As such, when the first PMOS transistor PM1 is turned off, the second PMOS transistor PM2 is turned on, and the third PMOS transistor PM3 is turned on, the operating voltage Vss is supplied to the active matrix organic light-emitting diode 200 through the second and third PMOS transistors PM2 and PM3, connected in series with each other, so that the organic light emitting diode (OLED) of the active matrix organic light-emitting diode 200 is turned on.

The organic light emitting diode (OLED) of the active matrix organic light-emitting diode 200 operating in the above-described manner may be deteriorated when being used for long periods of time. In the apparatus for compensating for deterioration in an AMOLED (active matrix organic light-emitting diode) according to this embodiment, the deterioration compensation voltage Vcom is periodically supplied to the organic light emitting diode (OLED) of the active matrix organic light-emitting diode 200, thereby preventing deterioration in the organic light emitting diode (OLED).

Specifically, the switching control unit 300 according to this embodiment is synchronized with the operation of the pixel driving unit 100 to thereby generate the switching control signal SSC in order to compensate for deterioration in pixels and supply the switching control signal SSC to the switch circuit unit 400.

In particular, the switching control unit 300 may be synchronized with the vertical synchronization signal Vsync of the image signal from the pixel driving unit 100 to thereby generate the switching control signal SSC in order to compensate for deterioration in pixels.

Furthermore, the switching control unit 300 may receive the vertical synchronization signal Vsync from the image processing unit 50 that supplies the switch signal Sn to the pixel driving unit 100.

For example, the vertical synchronization signal Vsync of the switching control unit 300 may be synchronized with the switch signal Sn from the image processing unit 50.

Referring to FIG. 2, when the switch circuit unit 400 is turned on according to the switching control signal SSC from the switching control unit 300, the switch circuit unit 400 may supply the deterioration compensation voltage Vcom to the anode of the active matrix organic light-emitting diode 200.

Here, when the deterioration compensation voltage Vcom is supplied to the anode of the active matrix organic light-emitting diode 200 for a charging time t2, shown in FIG. 2, a reverse voltage is applied to the organic light emitting diode (OLED) of the active matrix organic light-emitting diode 200, the depletion width DW of the organic light emitting diode (OLED) is increased. As a result, the deterioration of the organic light emitting diode (OLED) is prevented.

On the other hand, when the switch circuit unit 400 is turned off according to the switching control signal SSC from the switching control unit 300 for a charging time t1 or t3, as shown in FIG. 2, the deterioration compensation voltage Vcom is not supplied to the anode of the active matrix organic light-emitting diode 200.

Specifically, the switch circuit unit 400 may include a PMOS transistor PM41. When the PMOS transistor PM41 is turned on according to the switching control signal SSC from the switching control unit 300, the switch circuit unit 400 may supply the deterioration compensation voltage Vcom to the anode of the active matrix organic light-emitting diode 200.

On the other hand, when the PMOS transistor PM41 is turned off according to the switching control signal SSC from the switching control unit 300, the switch circuit unit 400 does not supply the deterioration compensation voltage Vcom to the anode of the active matrix organic light-emitting diode 200.

Here, the deterioration compensation voltage Vcom may be set to a voltage lower than the operating voltage Vss being supplied to the cathode of the active matrix organic light-emitting diode 200.

Referring to FIG. 3, for example, when the operating voltage Vss of −5V is supplied to the organic light emitting diode (OLED) of the active matrix organic light-emitting diode 200, the deterioration compensation voltage Vcom of −8V may be supplied to the organic light emitting diode (OLED) of the active matrix organic light-emitting diode 200.

In this case, when a reverse voltage is applied to the organic light emitting diode (OLED) of the active matrix organic light-emitting diode 200, holes inside the organic light emitting diode (OLED) move towards the anode, and electrons inside the organic light emitting diode (OLED) move towards the cathode, so that the depletion width DW of the depletion layer of the active matrix organic light-emitting diode 200 is increased.

As described above, in this invention, a reverse voltage is applied to an organic light emitting diode during an interval when an image is not displayed on the screen, thereby preventing deterioration.

This method can simplify a driving circuit structure when compared to that according to an existing method, thereby reducing a driving chip size to thus reduce costs.

As set forth above, according to exemplary embodiments of the invention, deterioration in pixels is prevented to thereby reduce the occurrence of afterimages and prevent image sticking.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for compensating for deterioration in an active matrix organic light-emitting diode being operated by a pixel driving, the apparatus comprising:
a switching control unit being synchronized with an operation of the pixel driving unit to thereby generate a switching control signal in order to compensate for deterioration in a pixel; and
a switch circuit unit connected between an anode of the active matrix organic light-emitting diode and a terminal of a deterioration compensation voltage, being turned on or off according to the switching control signal from the switching control unit, and supplying the deterioration compensation voltage to the anode of the active matrix organic light-emitting diode while being turned on.

2. The apparatus of claim 1, wherein the switching circuit unit is synchronized with a vertical synchronization signal of an image signal from the pixel driving unit to thereby generate the switching control signal in order to compensate for deterioration in a pixel.

3. The apparatus of claim 2, wherein the switching circuit unit comprises a PMOS transistor having a source connected to the terminal of the deterioration compensation voltage, a gate connected to a terminal of the switching control signal of the switching control unit, and a drain connected to the anode of the active matrix organic light-emitting diode.

4. The apparatus of claim 3, wherein the deterioration compensation voltage is a voltage lower than an operating voltage being supplied to the cathode of the active matrix organic light-emitting diode.

5. The apparatus of claim 3, wherein the switching control unit receives the vertical synchronization signal from an image processing unit supplying a switch signal to the pixel driving unit.

6. The apparatus of claim 5, wherein the vertical synchronization signal of the switching control unit is synchronized with the switch signal from the image processing unit.
